(19) United States
(12) Patent Application Publication
(10) Pub. No.: US 2006/0208237 A1
(43) Pub. Date: Sep. 21, 2006

(54) Fire retardant composition, use thereof for the manufacture of linoleum, fire retardant products made from this linoleum and application of these linoleum products

(76) Inventor: Erik Remko Dokkum Van, Heiloo (NL)

Correspondence Address: KNOBBE MARTENS OLSON & BEAR LLP, 2040 MAIN STREET, FOURTEENTH FLOOR, IRVINE, CA, 92614, US

(21) Appl. No.: 10/541,854

(22) PCT Filed: Jan. 8, 2004
(86) PCT No.: PCT/NL04/00007

§ 371 Date: Apr. 7, 2006

(30) Foreign Application Priority Data
Jan. 11, 2003 (NL) 1022358

(51) Int. Cl. C09K 21/00

(52) U.S. Cl. 252/601

(57) ABSTRACT

Composition with fire retarding properties with a high molecular polymer organic material of linoleum cement, as well as a fire retardant addition of aluminium hydroxide and optionally further fillers. This linoleum cement composition can contain up to 38 wt. of aluminium hydroxide. The composition can contain calcium carbonate as well in a fire retarding composition of 10-90 wt % of linoleum cement. In a linoleum cement composition can about half of the calcium carbonate present for linoleum manufacture be replaced through aluminium hydroxide. In this composition can further the linoleum cement composition contain 5-25 wt. % of both calcium carbonate as well as aluminium hydroxide, wherein the total weight percentage of both substances is 20-40 wt. %. The linoleum cement composition can comprise a mainly cellulose containing filler, such as wood flour, cork flour, short natural fibres or rayon fibres. The invention relates also to fire retardant linoleum manufactured by means of methods known per se for linoleum manufacture from the fire retarding linoleum cement mixtures concerned and there from formed shaped fire retarding objects suitable for covering of surfaces, such as floors, walls, ceilings, tables and wall boards. Finally the invention relates to other products which can be applied on a surface and end-use thereof.

The invention relates to a fire retarding composition, use thereof for the manufacture of linoleum, fire retardant products made from this linoleum and application of these linoleum products.

In EP-0390647 compositions with fire retarding properties are mentioned, comprising a high molecular organic material, a fire retarding addition of aluminium hydroxide and optionally further fillers.

In EP-0390647 on page 3, lines 3-9 is referred as part of the State of the Art to FR-2141948 and U.S. Pat. No. 2,832,326 where aluminium hydroxide is mentioned as addition to ethylene-vinyl acetate copolymer for fireproofing of this polymer. In EP-0390647 it is noted that one is of opinion that with the use of aluminium hydroxide, the application thereof is prevented through the too high costs and the too less useful effects. Further in EP-0390647 it is inter alias referred to the use of aluminium hydroxide exclusively as fire retardant in polymers, with in general rather minor useful effects. See for instance in Table B under experiment 3 on page 10 and the vertical line at the number 0 in FIG. 2, which indicates the fire retardation of amounts of aluminium hydroxide of 150, 175, 200, 225 and 250, respectively added as fire retardant to an organic polymer.

Surprisingly now, it appeared that addition of aluminium hydroxide to linoleum cement, in spite of the lesser effectiveness thereof for other polymers than linoleum cement, known from EP-0390647, imparts a surprisingly high fire proofing to the linoleum made there out. Linoleum, manufactured from a conventional linoleum cement mixture, which contains no aluminium hydroxide but limestone exclusively, has a fire proofing number of 4.5 kW/m2.

When one now replaces completely the normal percentage of 20-30 wt % limestone through aluminium hydroxide, the fire proofing number unexpectedly raises to values>8 kW/m2.

The special circumstance is that herewith is met to the novel norm for fire safety Class B, or >8 kW/m2.

Application of aluminium hydroxide in place of limestone in a linoleum cement mixture with linoleum manufacture is less obvious, due to less processing properties than limestone thereof, the to be expected useful effect mentioned in the introduction and the higher costs. The with respect to processing to linoleum and costs to obtain maximum percentage of aluminium hydroxide is about 38 wt. % in the linoleum cement composition.

As aluminium hydroxide, as mentioned before, is relatively expensive, a part thereof can be replaced by calcium carbonate, as known from the before mentioned EP-0390647, which relates to a synergetic acting fireproofing addition of calcium carbonate and aluminium hydroxide to a totally different polymer mixture than a linoleum cement mixture. It is in view of EP-0390647 certainly not obvious that a linoleum cement mixture with both compounds added there to, gives an excellent linoleum with respect to product quality and processing properties.

A new fire retarding composition, which contains both aluminium hydroxide and calcium carbonate might contain 10-90 wt. % linoleum cement.

In a linoleum cement composition is according to a preferred embodiment about half of the calcium carbonate present for the processing to linoleum replaced by aluminium hydroxide. Herewith an optimum is reached with respect to fireproofing of the product manufactured there from, and the processing properties of the mixture as well. Advantageously the new compositions might contain 5-25 wt. % of both calcium carbonate and aluminium hydroxide as well, wherein the total wt. percentage of both substances is 20-40 wt. %.

According to an advantageous embodiment the calcium carbonate can be wholly or partly replaced through limestone. This has the advantage of less processing of a natural product, resulting in lower costs of the linoleum and the there from made products.

According to Handbook of Chemistry and Physics, 72 nd Edition the mean composition of “limestone” is as follows: see page 14-7, table Chemical Composition of Rocks

| Element | Average limestone % |
|---|---|
| SiO2 | 5.19 |
| TiO2 | 0.06 |
| Al2O3 | 0.81 |
| Fe2O3 | 0.54 |
| MgO | 7.89 |
| CaO | 42.57 |
| Na2O | 0.05 |
| K2O | 0.33 |
| H2O | 0.77 |
| P2O5 | 0.04 |
| CO2 | 41.54 |
| SO3 | 0.05 |
| BaO | — |
| C | — |
| Total | 99.84 |

The table from the “Handbook” was adopted from Sedimentary Rocks (1948) “with permission of Pettijohn, author and Harper Brothers, publishers”.

In place of limestone one might think of another carbonate containing mineral, such as chalk for instance. The circumstances are dependent on the costs of the mineral in question, the processing properties of the linoleum cement mixture obtained therewith, and the properties of the linoleum obtained.

According to a preferred embodiment the fire retarding linoleum cement composition contains a filler mainly consisting of cellulose. Examples of cellulose containing fillers are wood flour, cork flour and short cellulose containing natural fibres. It is possibly as well to use regenerated cellulose fibres, such as short rayon fibres.

The most preferably used cellulose containing fillers are wood flour and cork flour.

Preferably wood flour and/or cork flour in concentrations of 20-40 wt. % are used in the linoleum cement mixture.

As mentioned before, the invention relates as well to fire retarding linoleum, manufactured from the before mentioned linoleum cement mixtures, with methods known per se for the manufacture of linoleum, linoleum products manufactured from this linoleum, manufacture of these products and the use of these products.

Most in general with linoleum products are meant shaped objects wholly or partly consisting of the new fire retardant linoleum.

Manufacture of linoleum products more especially relates to methods for the manufacture of elements or objects suitable for covering of floors, walls, ceilings, tables and wall boards.

The invention relates also to use by applying on a surface of the before mentioned products made from fire retardant linoleum.

Finally the invention relates to the so to call end-use of the building or wall board which through applying on one or more surfaces of a fire retardant linoleum product obtains an improved fire safety.

Without any intention to limitation, the invention extends, within the scope of the appended claims to possible other fire retardant compositions, products whereby these are used for the manufacture and the use of these products, which are not mentioned in the here before preceding specification.

1. A composition with fire retardant properties, comprising a high molecular organic material, and a fire retardant addition of aluminium hydroxide wherein the high molecular organic material is linoleum cement.

2. The composition according to claim 1, further comprising other fillers, wherein the linoleum cement composition contains up to 38 wt. % of aluminium hydroxide.

3. The composition according to claim 1, wherein the composition further comprises calcium carbonate and the fire retardant composition contains 10-90 wt. % linoleum cement.

4. The composition according to claim 3, wherein in a linoleum cement composition about half of the calcium carbonate present for the manufacture of linoleum is replaced by aluminium hydroxide.

5. The composition according to claim 4, wherein the linoleum cement composition contains 5-25 wt. % of both calcium carbonate and aluminium hydroxide, wherein the total weight percentage of both substances is 20-40 wt. %.

6. The composition according to claim 3, wherein the calcium carbonate consists wholly or partly of limestone or another calcium carbonate containing mineral.

7. The composition according to claim 1, wherein the fire retardant composition comprises a mainly cellulose containing filler.

8. The composition according to claim 7, wherein the mainly cellulose containing filler is wood flour and/or cork flour.

9. The composition according to claim 8, wherein the linoleum cement composition contains 20-40 wt. % wood flour and/or cork flour.

10-14. (canceled)

15. The composition according to claim 7, wherein the cellulose containing filler comprises wood flour, cork flour, short natural fibres or rayon fibres.

16. The composition according to claim 2, wherein the composition further comprises calcium carbonate and the fire retardant composition contains 10-90 wt. % linoleum cement.

17. The composition according to claim 4 wherein the calcium carbonate consists wholly or partly of limestone or another calcium carbonate containing mineral.

18. The composition according to claim 5 wherein the calcium carbonate consists wholly or partly of limestone or another calcium carbonate containing mineral.

19. The composition according to claim 2, wherein the fire retardant composition comprises a mainly cellulose containing filler.

20. The composition according to claim 3, wherein the fire retardant composition comprises a mainly cellulose containing filler.

21. A fire retardant linoleum, comprising a high molecular organic material, and a fire retardant addition of aluminium hydroxide, wherein the high molecular organic material is linoleum cement.

22. The fire retardant linoleum according to claim 21 in the form of a shaped object.

23. The fire retardant linoleum according to claim 21 in the form of an object suitable for the covering of a floor, wall, ceiling, table or wallboard.

24. The fire retardant linoleum according to claim 23, wherein the object is obtained by applying on a surface of linoleum elements manufactured from the fire retardant linoleum.
